(19) United States
(12) Patent Application Publication
(10) Pub. No.: US 2008/0072249 A1
(43) Pub. Date: Mar. 20, 2008

(54) User Designated Advertising Server

(75) Inventors: Shant Hovnanian, New York, NY (US); Marcos R. Lara, New York, NY (US); Sheldon Renan, Northridge, CA (US); Ted Gulesserian, Edgewater, NJ (US)

Correspondence Address: MRM, LLC, 56 MALDENHEAD ROAD, PRINCETON, NJ, 08540, US

(73) Assignee: SPEEDUS CORP., New York, NY (US)

(21) Appl. No.: 11/678,644

(22) Filed: Feb. 26, 2007

Related U.S. Application Data
(60) Provisional application No. 60/825,786, filed on Sep. 15, 2006.

(51) Int. Cl. H04N 7/10

(52) U.S. Cl. 725/34

(57) ABSTRACT

A system and method for allowing a user to designate the types of advertising to which they may be exposed based on preferences that may include their choice of faith, lifestyle, location, technology or cause. A user designated application acts as a reverse proxy and filters incoming HTML pages, replacing advertising URLs that link to content that does not conform to the user's preferences, with links to content that does conform. The function of reverse proxy may effectively be performed by a domain name server (DNS) designated by the user. The DNS may include a list of replaceable resource such that resolution of the domain name results in direction to an alternate server that serves substitute advertising conforming to the end-user's designated content type. The user's preference parameters may be stored either on a server accessed database, as a cookie on the user's computer or as a designated DNS.

### CROSS REFERENCE TO RELATED APPLICATIONS

This application is related to, and claims priority from, U.S. Provisional Patent application No. 60/825,786 filed on Sep. 15, 2006 by Shant Hovnanian, Marcos Lara and Sheldon Renan, entitled “User Directed Advertising Server”, the contents of which are hereby incorporated by reference.

### FIELD OF THE INVENTION

The present invention relates to methods and apparatus for serving graphics to web-browsers and more particularly to enabling a user to control the use of space in a web-page normally used to display advertising by selecting preference parameters.

### BACKGROUND OF THE INVENTION

Advertising on the Internet is a well-established business. The advertising may take the form of banner advertising, pop-up advertising or search based advertising.

Banner advertising, for instance, is used by many websites as it allows the sales and delivery of the advertising to be easily outsourced to a third party. This easy outsourcing is made possible by the way graphics images are downloaded into a web browser. When a hyper text mark up (HTML) document is viewed in a browser, the initial download of the page consists of HTML script only, without images. The images are loaded by the browser after parsing the initial script and locating uniform resource locators (URLs) indicating where the images are located. As a URL can be any address on the internet, the HTML page can serve text and images from a website owner's server and on the same page, images from a third party advertising server. In this way, specialized banner advertising firms such as, for instance, Doubleclick of New York, N.Y., may effectively aggregate the web audience from many different websites. This allows the advertising firms and their customers to benefit from the economies of scale.

Many users, however, do not welcome the intrusion of advertising on their browsers. As a result there are a variety of programs that counter banner advertising such as, but not limited to, the Webwasher™ application from Secure Computing Inc., of San Jose Calif. or the AdSubstract™ application from Trend Micro of Tokyo, Japan. These programs incorporate a variety of methods to block banner advertising, including blocking images that are the size of the well known banner advertising formats, or by blocking downloads from URLs of known third party advertising services

There are, however, segments of the web browsing community who only object to certain types of adverting or only want to see certain types of advertising. These user's or group's preferences may be based on, for instance, their religious faith, their concern for a cause such as, but not limited to, the environment, their choice of lifestyle, their commitment to a specific technology or their desire to only see advertising related to certain geographic location. The existing advertising blocking software does not easily allow such users to view only, or primarily, advertising based on their own preferences.

### SUMMARY OF THE INVENTION

Briefly described, the invention provides a system and method that allows a web user to control the advertising space on web pages they are surfing. The control of the advertising space includes allowing the user to designate the types of advertising to which they may be exposed. The user designated content type may be based on a user's preferences and may include, but is not limited to, their choice of faith, lifestyle, location, technology or cause, or some combination thereof. The method of controlling advertising space of this invention also allows the advertising space to be used to run applications. The applications run in the advertising space include, but are not limited to, applications that enable the use of the advertising space as a drag-and-drop location for effectively storing or forwarding clippings.

In a preferred embodiment, a user visits a website associated with an advertising service to download a user designtated advertising application. The user then runs the downloaded user designated advertising application on their computer or web access device. The user designated advertising application may act as a reverse proxy, i.e., a software module that filters incoming content going to an end-user's browser rather then coming from it. The tool that changes reverse proxy settings at a browser level may, for instance, be a browser plug-in. At a system level, the tool may be an independent software application running on the user's platform as an always on agent, or in a network stack. The reverse proxy filters incoming HTML pages, replacing advertising URLs that link to content that does not conform to the user's pre-selected preferences with links to advertisements and/or content that does conform, and/or to links to applications that the user has pre-selected. In this way non-conforming content is designated to be replaced with conforming content.

In a further embodiment of the invention, in which the user is a member of a shared secure access community such as, but not limited to, the Wibiki community provided by the Speedus Corporation of New York, N.Y., the reverse proxy may be associated with an authentication server that authorizes access to the shared secure access community, and may, for instance, be a software application running on the authentication server. The user's preference parameters may be stored either on a server accessed database, or as a cookie on the user's computer, or in some other suitable means. Based on the preference parameters, the reverse proxy may intercept and replace advertising content that does not conform to the user's pre-selected preferences. The replacement content may be nothing, or a small, blank image file, if the user selects to effectively block the advertising. Alternatively, the replacement content may be a substitute, but conforming, advertisement served by an ad-server associated with the community. The replacement may also, or instead, be an application served by an application server associated with the community. The replacement may also be some suitable combination of the previously mentioned replacements.

In a further preferred embodiment of the invention the function of the reverse proxy may effectively be performed by a domain name server (DNS) that may be remote from the end-user. The DNS may be designated by the user or by a software application running on the user's platform or internet access point. The DNS may, for instance, include a list of undesignated, replaceable resource locators that may, for instance, be domain names in URLs. The DNS may also include one or more replacement resource locators that may, for instance, be alternate internet protocol addresses. The resolution of the domain name may then, for instance, result in hypertext protocol (HTTP) requests being directed to an alternate, user designated ad-server that responds by serving substitute advertising or other or content that conforms to the end-user's designated content type.

These and other features of the invention will be more fully understood by references to the following drawings.

### BRIEF DESCRIPTION OF THE DRAWINGS

FIG. 1 is a schematic drawing of a wireless network implementing one embodiment of the present invention.

FIG. 2 is an interaction diagram representing steps taken in setting up one embodiment of the present invention.

FIG. 3 is an interaction diagram representing steps taken in using one embodiment of the present invention.

FIG. 4 is a schematic drawing of a web page created using one embodiment of the present invention.

FIG. 5 is a schematic drawing of a network implementing a further embodiment of the present invention.

FIG. 6 is an interaction diagram representing steps taken in using a further embodiment of the present invention.

### DETAILED DESCRIPTION

The present invention applies to methods and apparatus for serving graphics to web-browsers and more particularly to systems and methods for enabling a user to control the use of space in a web-page typically used to display advertising. The methods and apparatus of the invention may, in some embodiments, be thought of as being directed to the notion that users own the space on their browsers, and to providing them with the tools to retake control of that space, including the space sometimes appropriated for advertising by third party content providers.

A preferred embodiment of the invention will now be described in detail by reference to the accompanying drawings in which, as far as possible, like elements are designated by like numbers.

Although every reasonable attempt is made in the accompanying drawings to represent the various elements of the embodiments in relative scale, it is not always possible to do so with the limitations of two-dimensional paper. Accordingly, in order to properly represent the relationships of various features among each other in the depicted embodiments and to properly demonstrate the invention in a reasonably simplified fashion, it is necessary at times to deviate from absolute scale in the attached drawings. However, one of ordinary skill in the art would fully appreciate and acknowledge any such scale deviations as not limiting the enablement of the disclosed embodiments.

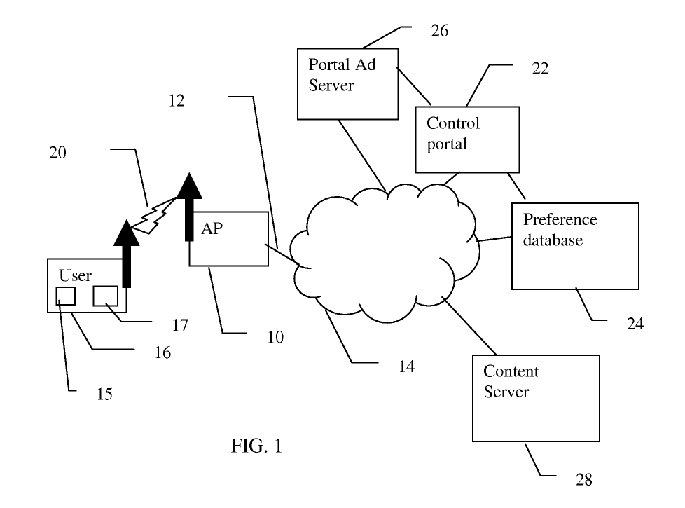

FIG. 1 is a schematic drawing of a wireless network implementing one embodiment of the present invention. The network includes a network access point 10, a high speed link 12, a network 14, an end-user network access device 16, a web-browser 15, a reverse proxy 17, a community control portal 22, a preference database 24, a portal ad-server 26 and a content server 28.

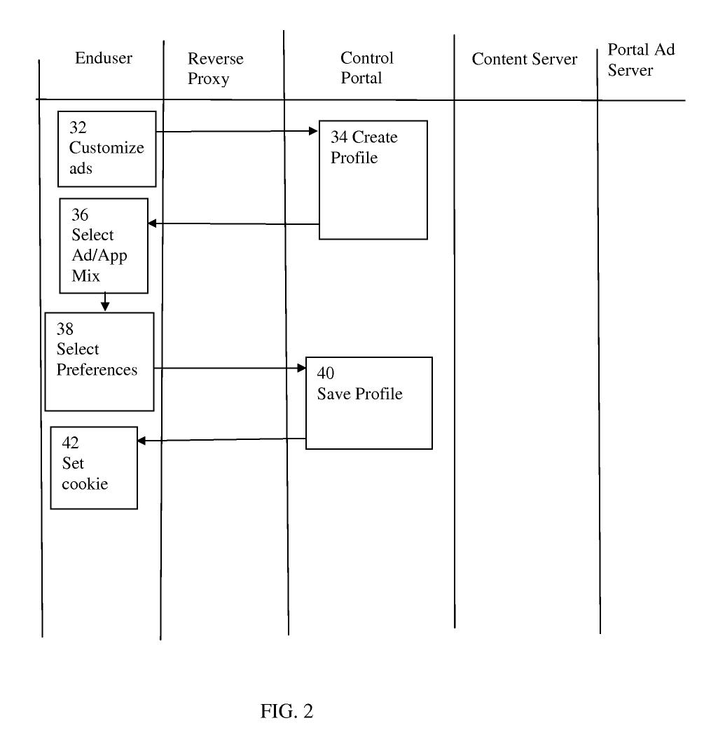

FIG. 2 is an interaction diagram representing steps taken in setting up one embodiment of the present invention. In step 32, an end-user elects to customize the advertising that will be displayed on their browser when surfing the internet using the end-user network access device 16. The end-user may access the community control portal 22 in step 32 in order to create a profile. Creation of a profile may include the end-user interactively selecting the advertising and application ratio in step 36. The step may take the form of selecting from a menu served by the community portal 22, and may include options such as, but not limited to, displaying no advertising, displaying only applications, displaying normal advertising to be used as applications, displaying only advertising that conforms to a set of preferences, showing advertising that conforms to a set of preferences to be used as applications, or some combination thereof.

In step 38, the end-user selects preferences. These preferences may include, but are not limited to, preferences for advertising related to the kind of adverts, i.e., banner advertisements, video advertisements, audio advertisements or pop-up advertisements, the subject of the advertising, the tone of the advertisements, i.e., humorous or informative, the source of the advertisements, the community providing the advertisements or the technology used by the community providing the advertisements. The preferences may also, or instead, include, but are not limited to, the end-users choice of faith, lifestyle, location or cause, or some combination thereof. By selecting these preferences, or combinations of preferences, the end-user may designate delivery of a type or range of content that may be considered as the end-user's designated content type. A member of a particular religious faith may, for instance, only designate advertising from advertising sources that do not include images of or references to alcohol. A member of a group dedicated to free, but secure, wireless access may, for instance, choose to designate to receive only content provided by that group.

The preferences may also allow the user to select applications that enable the use of advertising space to run applications such as, but not limited to, using an advertising space as a drag-and-drop location for effectively storing clippings, or for sending clippings dragged to an advert via e-mail to an e-mail address. Such applications may also enable a dragging and dropping an advertisement or an image to a storage, or having the URL stored or sent, via e-mail or instant message, to one or more recipients, or some combination thereof. The application may include counters on the advertising indicating how may items are stored in the location represented by the advertising space, or how many items have been emailed via the advertising space. By using the adverting space as an application, the efficacy of the advertising may be enhanced.

In step 40, the community portal 22 saves the profile created by the end-user in the form of profile parameters. Saving the profile may, for instance, take the form of storing the profile parameters in a data-base or of step 42 of setting a cookie on the end-user's network access device 16, or a combination thereof.

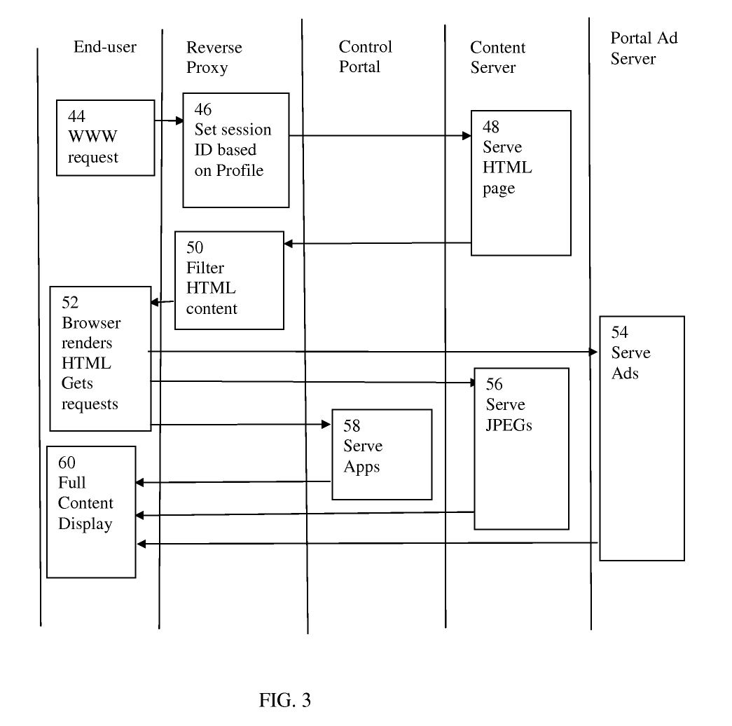

FIG. 3 is an interaction diagram representing steps taken in using one embodiment of the present invention.

In step 44 an end-user requests information from the World Wide Web by submitting a uniform resource locator (URL) to a web-browser 15 running on the end-user's network access device 16. In step 46, a reverse proxy 17 intercepts the request and sets a session identifier based on the end-user's profile parameters. The profile parameters may be obtained from the cookie it is stored in, or from a database it is stored in, or a combination thereof. Although the reverse proxy 17 is shown in FIG. 1 as running on the end-user's network access device 16, it will readily be appreciated by one of ordinary skill in the networking and programming art that such a reverse proxy 17 may be located at any suitable point in the network including, but not limited to, the network access point 10 or the community portal 22 in the event of a portal based secure access community.

In step 48, the content server 28 indicated by the end-user selected URL may serve up the requested information in the form of a hyper text mark up language (HTML) page. In step 50, the reverse proxy 17 filters the HTML page based on the end-users profile parameters, and selectively replaces advertisements in accordance with those preference parameters, or the end-user's designated content type.

In step 52, the web-browser 15 running on the end-user's network access device 16 renders the HTML page, and requests the images represented by URL's embedded in the HTML. These requests now result in a number of actions. In step 54, advertisements in accordance with the end-user's designated content type are served via the portal ad-server 26. In step 56, non-advertising images, typically in JPEG or TIFF format, are served by the content server 28. In step 58, the community portal 22 serves applications in accordance with the end-users preference parameters, that may be associated with one or more of the advertisements served by the portal ad-server 26.

In step 60, the full contents of the HTML page, along with requested images and advertising that conforms to the end-user's designated content type, are displayed.

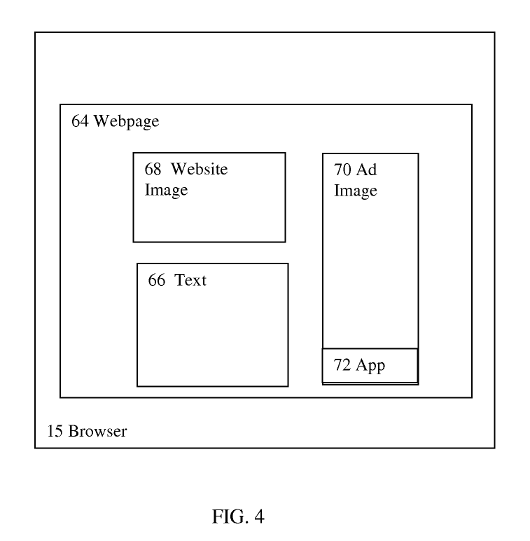

FIG. 4 is a schematic drawing of a web page created using one embodiment of the present invention. The web-browser 15 displays a web-page 64 that may contain text 66 and images 68 delivered from, for instance, the content server 28. The web-page 64 may also contain advertising 70 delivered from, for instance, the portal ad-server 26. The advertising 70 may be associated with an application such as, but not limited to, a well-known Java applet. Such an applicaiton may include an application tool bar 72. The application tool bar 72 may include, but is not limited to, a drop down menu to display, for instance, items stored in the space linked to the advertising 70. The linked storage space may include, but is not limited to, an e-mail inbox, a file on the end-user's network access device 16 or a file on the community portal 22 or some combination thereof.

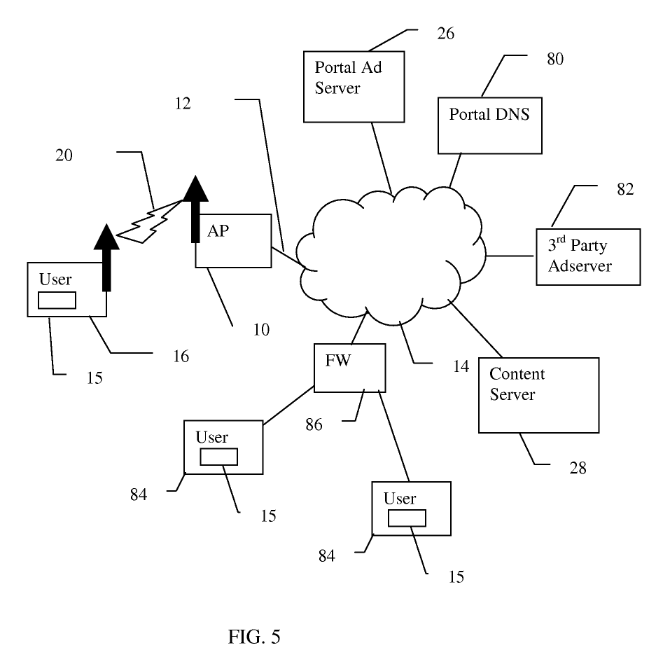

FIG. 5 is a schematic drawing of a network implementing a further preferred embodiment of the present invention. In addition to the network access point 10, the high speed link 12, the network 14, the end-user network access device 16, the web-browser 15, the portal ad-server 26 and the content server 28, the embodiment of FIG. 5 includes a portal domain name server 80, a third party ad-server 82 and a second user 84. The second user 84 is an exemplary user intended to illustrate that the invention may be implemented on a wired connection to the internet as well as via a wireless access point 10.

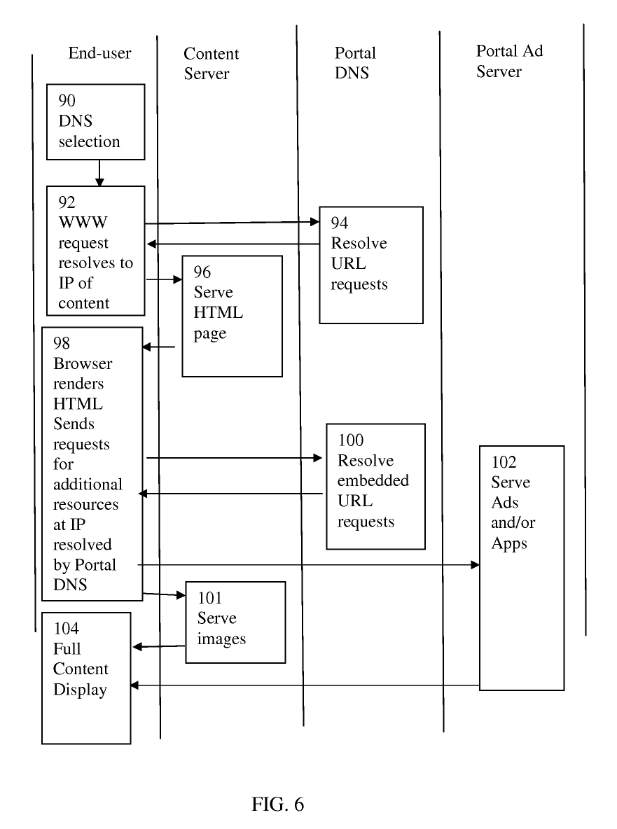

FIG. 6 is an interaction diagram representing steps taken in using the further, exemplary embodiment of the invention shown in FIG. 5.

In step 90 the user selects to use the portal domain name server 80 to resolve domain names within uniform resource locators (URLs). This may be done by the user setting this option manually. For instance, an end-user with an end-user network access device 16 that operates using the Microsoft Windows XP™ operating system provided by Microsoft, Inc. of Redmond, Wash. may select to use the portal domain name server 80 by the following method. The user may right click on the “Start” menu and then select the “My network places” option. This will reveal a window with an option to “View network connections”. The end-user may click on the “View network connections” to reveal the end-user network access device 16's mode of connection to the Internet. This may be, but is not limited to, a high speed internet connection. The end-user may click on the high speed internet connection icon to reveal the status of the connection and a button labeled “Properties”. The end-user may click on the “Properties” option to reveal a further window showing the elements the connection is currently using. The user may highlight the Internet Protocol (TCP/IP) option and then select “Properties”. A further window will then show the general properties of the Internet Protocol running on the end-user network access device 16. The default properties generally include “Obtain DNS server address automatically”. The user may, however, elect to use a specific DNS server by selecting the “Use the following DNS server addresses” option and then typing in the 10 digit address of the portal domain name server 80.

The selection of the portal domain name server 80 may also, or instead, be done automatically by a suitable application running on the end-user network access device 16, the network access point 10 or on any gateway server linking a user's device to the internet. For instance, by downloading and running a suitable application, an end-user may designate their end-user network access device 16 to use a specified portal domain name server 80. One of ordinary skill in the computing and networking art will readily appreciate the feasibility of such an application using the technology described in detail in, for instance, U.S. Pat. No. 7,089,325 issued to Murtza et al. on Aug. 8, 2006 entitled “Method and apparatus for URL forwarding”, the contents of which are hereby incorporated by reference.

The application that effectively allows the end-user to select a specific DNS may also provide other functionality desired by the end-user such as, but not limited to, preferred access to a network or access point, or some other service such as, but not limited to, an internet phone service, a dating service, a video clip providing service, an information providing service, an image hosting service, a social networking service or other internet business. An advantage of such an arrangement is that the end-user may, for instance, be provided with a valuable service that is supported by advertising revenue, but viewing the advertising does not interfere with the provision of the valuable service.

In a preferred embodiment the particular portal domain name server 80 selected by an end-user may be related to the end-users preferences that may include, but is not limited to, their choice of faith, lifestyle, location or cause, or some combination thereof. In that manner, the end-user may select to be exposed only to advertising or other information relevant to their preferences, and so determine the end-user's designated content type.

In step 92, the end-user submits a request for a document or web page via their web-browser 15. The request may for, instance, take the form of a URL such as, for example:

http://www.example.com/path/file.html

The web-browser 15 will effectively translate this into a request to connect to the host at domain name www.example.com. Once a connection is established to the host, the host will then perform the Hypertext Transfer Protocol (HTTP) function: GET /path/file.htm.

In step 94, the portal domain name server 80 resolves the domain name into an IP address that is returned to the end-user's web-browser. In IPv4, the address is a 32 bit number that is typically displayed as 4 decimal numbers in standard dotted-decimal IP address notation, such as, for example, 212.202.126.70. This number is the unique identifier of the host machine, i.e., in this example the domain name www.example.com is associated with the host machine having IP address 212.202.126.70.

Having obtained the IP address of the host machine from the DNS, the web-browser sends the HTTP request to GET /path/file.htm to the content server 28 that has that IP address. In step 96, the content server 28 then performs the appropriate HTTP request. In this example, the content server 28 delivers the HTML document located on its file system by the address /path/file.htm to the web-browser 15 on the end-user network access device 16.

In step 98 the web-browser 15 on the end-user network access device 16 attempts to render the HTML document delivered from the content server 28. Embedded within the HTML document may be requests for additional content such as, but not limited to, images and advertising, that may also be in the form of images. Typically the additional images will reside on a file system on the content server 28 while the images for the advertising may reside on a separate third party ad-server 82. The requests for the additional material typically take the form of a URL as detailed above.

When the host-name of the request for additional graphics is processed in step 100 by the portal domain name server 80, the IP address for the content server 28 will be provided and the request directed there by the web-browser 15. In step 101 the content server 28 may then serve the requested material that may be, but is not limited to, images in JPEG or TIFF format.

The host-name associated with the request for advertising may, however, be one of the domain names that is on a list of domain names to be substituted because of the end-user's preferences, i.e., the hosts associated with the domain names serve content elements that do not conform to the end-user's designated content type.

To replace the non-conforming content element with alternate, conforming content elements, the portal domain name server 80 may, for instance, substitute the IP address of the portal ad-server 26 for the host-name of the non-conforming ad-server. The HTTP request will then be directed to the portal ad-server 26. The redirected request may, however, contain a path name that is intended for a file structure on the third party ad-server 82. This file structure may not exist on the portal ad-server 26. This problem may be overcome by, for instance, use of a rewrite engine. A rewrite engine is a piece of web server software used to modify URLs before fetching the requested item. Rewrite engines are typically used for a variety of purposes such as making website URLs more user and search engine friendly, preventing undesired “inline linking or hot linking” of web content or of concealing the (web address-related) inner workings of a website to users. URL rewriting may be performed by, for instance, a rewrite engine such as the “mod_rewrite” module on the Apache HTTP server provided by the Apache Software Foundation of Delaware. URL rewriting typically involves the use of rewrite rules that are commands in which a pattern identified with a regular expression is replaced with a substitute expression. For instance, an expression:

Rewrite:\.(gif|jpg|png|tiff)$http://www.padserver.com/pathsubstitute.gif

may have the effect of substituting the new file path applicable to the portal ad-server 26 for any file path previously associated with the request for a gif, jpg, png or tiff image on the server.

In step 102, the portal domain name server 80 receives and processes any HTTP requests directed there by the web-browser 16, including any necessary URL re-writing. The new content is sent to the web-browser 15 of the end-user network access device 16 where it is displayed in step 104 in place of the content that would otherwise have originated at the third party ad-server 82, and along with any additional content from the content server 28.

In a further prefer embodiment, a second end-user 84 may be part of a local area network connected to the web via a server 86 that may, for instance, also act as a firewall. The portal domain name server 80 may in such a set up be a software module running on the server 86. In this way, a corporation or enterprise may allow workers to access general, non-work related, sites during work hours in return for substituting the advertising content on some or all of the sites with corporate related advertising, information or inspirational messages. The corporation mandated end-user's designated content type may, for instance, include information relevant to the corporation, inspirational information, with or without links back to the corporate website, material requiring to be disseminated to the company, pictures of management or staff, or information about company services or products.

In a further embodiment of the invention, the end-user may elect a primary and a secondary alternate DNS. The primary alternate DNS would be used if available and the secondary automatically switched in if the primary alternate DNS is unavailable. Switching between the primary and secondary may also or instead be accomplished by the user using a suitable switch.

In a further embodiment of the invention, one DNS may serve advertisements and another may server applications. Different DNS's may also, or instead, each serve different types of advertisements or applications that may reflect the user's preferences. In this way the user may, for instance, designate a content type by the selection of a DNS known to serve advertising that conforms to the user's preferences that may include, but are not limited to, a religious faith, a concern for the environment, a choice of lifestyle, a commitment to a specific technology and a desire to only see advertising related to a specific geographic location, or a combination thereof.

One of ordinary skill in the computing and networking art will appreciate that the elements of the various embodiments described above may be combined in various combinations. For instance, the DNS embodiment of the invention may be combined with the control portal used to create profiles that determine the nature of the end-user's designated content.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention. Modifications may readily be devised by those ordinarily skilled in the art without departing from the spirit or scope of the present invention.

What is claimed:

1. A method of serving user designated content, said method comprising the steps of:
determining an end-user designated content type;
detecting if a first content element in a web-page conforms to said designated content type; and
replacing said first content element with a second content element conforming to said designated content type, if said first content element fails to conform to said designated content type.

2. The method of claim 1 wherein determining an end-user designated content type further comprises receiving a selected preference parameter.

3. The method of claim 2 wherein said preference parameter is indicative an end-user's preference selected from the group consisting of a religious faith, a concern for the environment, a choice of lifestyle, a commitment to a specific technology and a desire to only see advertising related to a specific geographic location, or a combination thereof.

4. The method of claim 1 wherein said detecting if a first content element conforms to said designated type further comprises parsing a uniform resource locator (URL) associated with said first content element.

5. The method of claim 4 further comprising comparing a requested host-name within said (URL) with a list of known non-conforming host-names.

6. The method of claim 5 wherein replacing said first content element with a second content element conforming to said designated content type further comprises associating a substitute internet protocol (IP) address associated with a substitute host with said requested host-name.

7. The method of claim 6 further comprising serving, by said substitute host, said second content element.

8. The method of claim 7 wherein said serving said second content element further comprises rewriting said URL to accommodate a file structure of said substitute host.

9. The method of claim 1 wherein replacing said first content element with a second content element conforming to said designated content type further comprises locating one or more external code elements on said web page, and substituting one or more substitute code elements for said external code elements such that a substitute content type is displayed in place of an original content type.

10. The method of 9 further comprising substituting an IP address of the said external code element with a substitute IP address that points to said substitute code element.

11. A system for serving user designated content, comprising:
means for determining an end-user designated content type;
means for detecting if a first content element in a web-page conforms to said designated content type; and
means for replacing said first content element with a second content element conforming to said designated content type, if said first content element fails to conform to said designated content type.

12. The system of claim 11 wherein said means for determining an end-user designated content type further comprises a selected preference parameter indicative of an end-user's preference selected from the group consisting of a religious faith, a concern for the environment, a choice of lifestyle, a commitment to a specific technology and a desire to only see advertising related to a specific geographic location, or a combination thereof.

13. The system of claim 12 wherein said means for replacing said first content element with a second content element conforming to said designated content type further comprises means for locating one or more external code elements on said web page, and substituting one or more substitute code elements for said external code elements such that a substitute content type is displayed in place of an original content type.

14. An apparatus for serving user designated content, comprising:
an end-user designated content type indicative of an end-user's preference selected from the group consisting of a religious faith, a concern for the environment, a choice of lifestyle, a commitment to a specific technology and a desire to only see advertising related to a specific geographic location, or a combination thereof;
a detection software module, running on a first device, for detecting if a first content element in a web-page conforms to said designated content type; and
a replacement software module, running on said first device, for replacing said first content element with a second content element conforming to said designated content type, if said first content element fails to conform to said designated content type.

15. The apparatus of claim 14 wherein said replacement module further comprises instructions for locating one or more external code elements on said web page, and substituting one or more substitute code elements for said external code elements such that a substitute content type is displayed in place of an original content type.

16. A computer-readable medium, comprising instructions for:
determining an end-user designated content type;
detecting if a first content element in a web-page conforms to said designated content type; and
replacing said first content element with a second content element conforming to said designated content type, if said first content element fails to conform to said designated content type.

17. The computer-readable medium of claim 16 wherein said instructions for determining an end-user designated content type further comprise instructions for receiving a selected preference parameter indicative of an end-user's preference selected from the group consisting of a religious faith, a concern for the environment, a choice of lifestyle, a commitment to a specific technology and a desire to only see advertising related to a specific geographic location, or a combination thereof.

18. The computer-readable medium of claim 16 wherein said instructions for replacing said first content element with a second content element conforming to said designated content type further comprises instructions for locating one or more external code elements on said web page, and substituting one or more substitute code elements for said external code elements such that a substitute content type is displayed in place of an original content type.

19. A computing device comprising: a computer-readable medium comprising instructions for:
determining an end-user designated content type indicative of an end-user's preference selected from the group consisting of a religious faith, a concern for the environment, a choice of lifestyle, a commitment to a specific technology and a desire to only see advertising related to a specific geographic location, or a combination thereof;
detecting if a first content element in a web-page conforms to said designated content type; and
replacing said first content element with a second content element conforming to said designated content type, if said first content element fails to conform to said designated content type.

20. The computing device of claim 19 wherein said instructions for replacing said first content element with a second content element conforming to said designated content type further comprises instructions for locating one or more external code elements on said web page, and substituting one or more substitute code elements for said external code elements such that a substitute content type is displayed in place of an original content type.
